(19) United States
(12) Patent Application Publication
(10) Pub. No.: US 2010/0117956 A1
(43) Pub. Date: May 13, 2010

(54) DISPLAY SYSTEM AND METHOD FOR CONTROLLING AN ON-SCREEN DISPLAY WITHIN A DISPLAY SCREEN

(75) Inventors: KUAN-YI WU, TAIPEI COUNTY (TW); CHENG-HSUN SUNG, TAINAN CITY (TW); SHIH-CHANG KUO, TAIPEI CITY (TW); YIA CHUN CHENG, KEELUNG CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: CHI LIN TECHNOLOGY CO., LTD., TAINAN COUNTY (TW)

(21) Appl. No.: 12/409,070

(22) Filed: Mar. 23, 2009

(30) Foreign Application Priority Data
Nov. 11, 2008 (TW) 097143475

(51) Int. Cl. G09G 5/00

(52) U.S. Cl. 345/156

(57) ABSTRACT

A display system is used for controlling an on-screen display within a display device. The on-screen display is a text information including a literal string formed by combining several numbers of letters. The display system includes a memory device for storing pieces of letter information, a controller to download a coding chart upon initialization of the display device. The coding chart includes string-forming codes and letter-forming codes. The coding chart further includes groups of string-forming codes for encoding different literal strings. The string-forming codes and the letter-forming codes correspond to the letter information in the memory. Upon receipt of an external command corresponding to a specific string-forming code, the controller fetches a letter-forming code from the coding chart based on the specific string-forming code and letter information from the memory device based on the respective letter-forming code, thereby encoding and displaying the literal string over the display screen.

This application claims the benefits of the Taiwan Patent Application Serial NO. 097143475, filed on Nov. 11, 2008, the subject matter of which is incorporated herein by reference.

### BACKGROUND OF THE INVENTION

1. Field of the Invention

The present invention relates to a display system and method for controlling an on-screen display within a display screen, more particularly to a display system which controls an on-screen display within a display screen and which uses lesser memory device for accomplishing the task.

2. Description of the Prior Art

A display screen is the best Human Media Interaction. When the display screen is in use, it is often required to adjust its brightness, viewing options, channels, color contrast, screen dimension and horizontal or vertical position of the screen display in order to provide the outmost viewing ability. Generally speaking, the aforesaid features of the display screen are default during the mass production. After sale of the display screen (or the display device), in case the end user wishes to adjust these features, then the on-screen display within the display screen is applied.

The on-screen display will appear in the display screen upon switch-on operation and an input device (such as a remote control) is applied to adjust the parameters of the on-screen display so as to set the background and features of the screen display in the display screen.

A conventional display system with OSD ability requires a relatively large hardware, such as ROM (Read Only Memory) and RAM (Random Access Memory). The on-screen display usually consists of a text information and an Icon. The text information includes a display column consisting of a plurality of literal strings or bar charts. Each literal string is formed by combining several numbers of letters. In each literal string, some letters may be repeatedly used in addition to its color, font and etc. . . . According to the prior art, all of the literal strings are fully stored within the memory device (usually in ROM) and they will be downloaded within the RAM upon initialization of the display system.

It takes tremendously large memory device so that the cost of the hardware structure is high and the response speed is slow and is therefore not beneficial f or the market competition. For instance, an X-ray film for medical display should have high resolution in order to assist in finding out the disease. If the text information in the screen display is needed to be enlarged, it requires tremendously large memory source according to the prior art technology.

In addition, in case the display is required to be rotated, the text information (or the X-ray film) in the display screen also rotates simultaneously with the display screen. Generally, the display screen is rotated 90° from its initial position. In order to complement with and provide accurate two dimensional rotation of the display screen, the apparatus requires twice of its initial storage space, thereby wasting a great deal of memory device and causing a burden for the processor. Thus, the hardware device of the X-ray apparatus needs to be increased to comply with the added memory, which is against the economic trend for the manufacturers.

Therefore, the main object of the present invention is to provide a display system and the method thereof, where, a relatively large memory device can be economized and which includes icon and control settings that can be independently and simultaneously controlled so as to overcome the drawbacks encountered during use of the prior art display system.

### SUMMARY OF THE INVENTION

The object of the present invention is to provide a display system and the method thereof, where, a relatively large memory device can be economized and which includes icon and control settings that can be independently and simultaneously controlled so as to economize the expense of the hardware and lowers the processing load of the processor, thereby quickening the operation speed of the processor. In practical, the load of ROM and RAM is reduced apparently.

A display system of the present invention is used for controlling an on-screen display within a display screen of a display device. The on-screen display is a screen data in the form of a text information including a display column consisting of a literal string formed by combining several numbers of letters.

The display system accordingly includes a memory device, a controller and a text buffer.

Upon initialization of the display device, the controller downloads and temporarily stores a coding chart that includes a group of string-forming codes and a group of letter-forming codes. The coding chart further includes different groups of string-forming codes for encoding different types of the literal strings. The string-forming codes and the letter-forming codes are corresponding to the several pieces of letter information in the memory device.

Upon receipt of an external command corresponding to a specific string-forming code, the controller fetches a respective letter-forming code from the coding chart based on the specific string-forming code and a respective piece of letter information from the memory based on the respective letter-forming code, thereby encoding the literal string and displaying the literal string over the display screen.

The text buffer is used for temporarily storing the literal strings. The letter parameters for setting feature of a letter are also stored in the text buffer. An output buffer is used for temporarily storing the icon from the memory device and the text information from the text buffer, and thus an assembly of the icon and the text information is displayed over the display screen 31.

In the display system and method of the present invention, the memory device is stored with several pieces of letter information. The coding chart can be downloaded with the assistance of the controller for encoding the literal string by fetching the string-forming codes and the letter-forming codes from the coding chart, thereby economizing the expense of the hardware and lowers the processing load of the processor, which, in turn, quickens the operation speed of the processor. In practical, the load of ROM and RAM is reduced apparently.

### BRIEF DESCRIPTION OF THE DRAWINGS

Other features and advantages of this invention will become more apparent in the following detailed description of the preferred embodiment of this invention, with reference to the accompanying drawings, in which:

FIG. 1A illustrates a display screen of a display system according to the present invention, wherein the display screen shows a screen display including a literal string;

FIG. 1B illustrates a display screen of the display system according to the present invention, wherein the display screen shows a screen display including a bar chart;

FIG. 2 shows functions of the display system of the present invention;

FIG. 3 illustrates how an on-screen display in the screen display is controlled to change its position and orientation with respect to the display screen of the display system of the present invention; and

FIG. 4 shows a block diagram illustrating the steps in the display method of the present invention to be applied in a display system for controlling an on-screen display in a display screen.

### DETAILED DESCRIPTION OF THE PREFERRED EMBODIMENTS

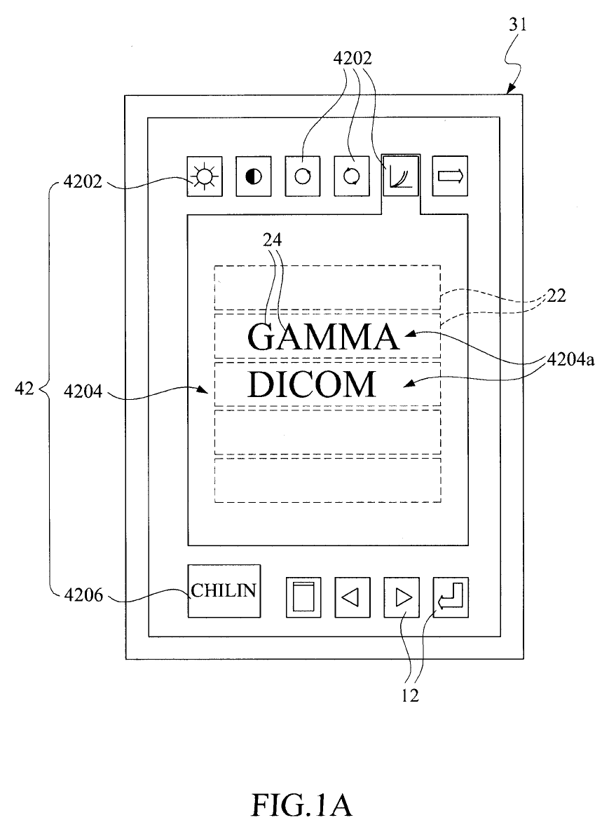

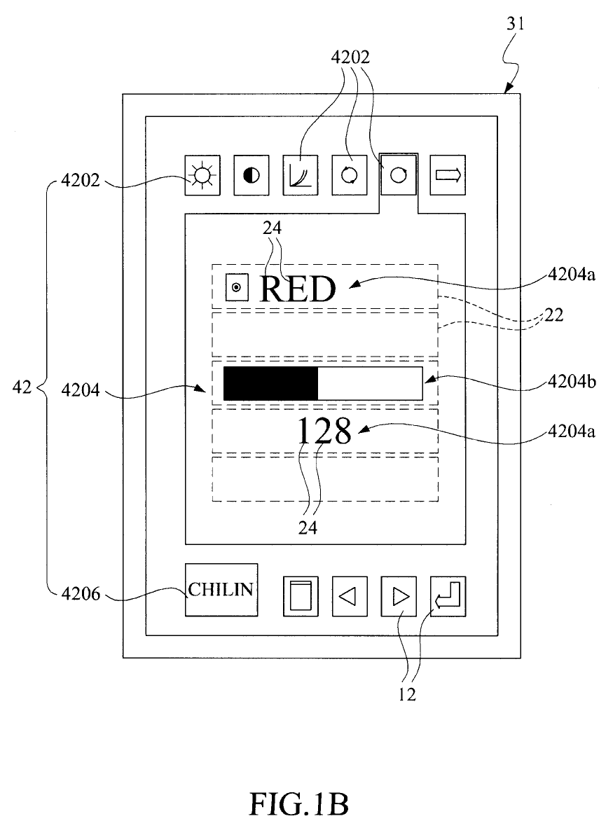

FIG. 1A illustrates a display screen 31 of a display system according to the present invention, wherein the display screen 31 shows a screen display including a literal string 4204a. FIG. 1B illustrates the display screen 31 of the display system according to the present invention, wherein the display screen 31 shows a screen display including a bar chart 4204b. The screen display includes a screen data 42 having an upper section formed with a plurality of icons 4202, a middle section with a text information 4204 generated due to clicking a respective icon 4202 and a lower section formed with a trade logo 4206.

The icons 4202 can be optionally selected and upon clicking a respective icon 4202 and a corresponding text information 4204 will appear below it. In FIG. 1A, the text information includes a display column consisting of five rows 22 of information. Each row 22 is a literal string 4204a, as shown in FIG. 1A or a bar chart 4204b, as shown in FIG. 1B.

In case the text information 4204 includes the literal strings 4204a, where each literal string 4204a is formed by combing several numbers of letters 24. As best shown in FIG. 1A, the first literal string 4204a is [GAMMA] formed by combining five letters 24, the second literal string 4204a is [DICOM] formed by combining five letters 24 and respectively occupying the second and third rows 22 while the fourth and fifth rows 22 remain blank.

The text information 4204 may include the bar chart 4204b in addition to the literal string 4204a, as shown in FIG. 1B, where the first literal string 4204a is [RED] formed by combing three letters 24 and is occupying the first row 22. The second literal string 4204a is [128] formed by combining three letters 24 and is occupying the fourth row 22. The third row 22 shows a bar chart 4204b while the second and fifth rows 22 remain blank.

The trade logo 4206 in fact is a are drawing, and therefore has no function ability. The screen data 42 of the screen display further has a few function keys 12 to permit the user to operate.

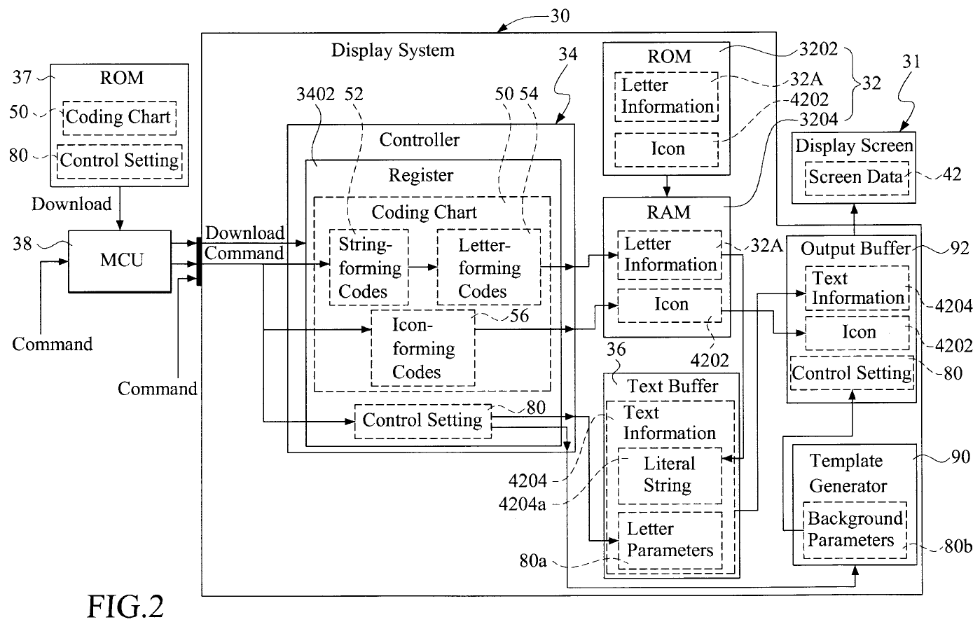

FIG. 2 shows functions of the display system 30 of the present invention. The display system 30 of the present invention is used for controlling the on-screen display (the screen data 42) within the display screen 31. As shown in FIGS. 1A and 1B, the text information 4204 of the screen data 42 includes five rows 22, each row showing a literal string 4204a or a bar chart 4204b, wherein the literal string 4204a is formed by combining several numbers of letters 24.

The text information 4202 will be described first while the icons 4202 and the control setting 80 will be deal with later. The display system 30 of the present invention further includes a memory device 32, a controller 34 and a text buffer 36.

The memory device 32 is used for storing several pieces of letter information 32A. The memory device 32 uses black and white levels for recording the several pieces of letter information 32A. The memory device 32 further includes a ROM (read-only memory) 3202 for permanently storing the several pieces of letter information 32A and a RAM (random access memory) 3204 for temporarily storing the several pieces of letter information 32A downloaded from the ROM 3202 during initialization of the display system 30.

The controller 34 includes a register 3402 for downloading and temporarily storing a coding chart 50 upon initialization of the display system 30. The coding chart 50 includes a group of string-forming codes 52 and a group of letter-forming codes 54. The coding chart 50 further includes different groups of string-forming codes 52 for encoding different types of the literal strings 4204a. The string-forming codes 52 and the letter-forming codes 54 are correspond to the several pieces of letter information 32A.

Upon receipt of an external command corresponding to a specific string-forming code 52, the external command is transferred to the processor 38 via a flexible cable or an interface. Note that, the display device may include a software device for conducting the fetching and transferring of the control setting to the controller 34 via the flexible cable or the interface.

At this time, the controller 34 fetches a respective letter-forming code 54 from the coding chart 50 based on the specific string-forming code 52 and a respective piece of letter information 32A from the memory device 32 based on the respective letter-forming code 54, thereby encoding the literal string 4204a and displaying the literal string 4202a over the display screen. The literal string 4204a may consist of several identical letters 24 (i.e. a single letter is repeatedly used). Since the memory device 32 is stored with only one piece for each of the several pieces of letter information, a relatively large amount of storage space is reduced in the memory device 32.

In real application, the memory circuit in the built-in chipset serves as the text buffer 36 for quickly and temporarily storing the literal strings 4204a for future use and the literal strings 4204a are displayed over the display screen 31.

The display screen 31 further includes a ROM (read-only memory) 37 and a MCU (microprocessor) 38. In this embodiment, EPROM 3202 (Erasable Programmable Read-Only Memory) or EEPROM 3202 (Electrically Erasable Programmable Read-Only Memory) is used for the ROM (read-only memory) 37, in which, the control setting 80 and the coding chart 50 are stored in advance.

During the initialization of the display screen 31, the processor 38 will download the control setting 80 and the coding chart 50 from the ROM 37 and transfer the same to the controller 34.

The control setting 80 is used for setting display modes of the screen data 42 (the on-screen display). The control setting 80 further includes background parameters 80b for setting a background feature of the screen display in the display screen 31 and letter parameters 80a for setting feature of a letter. The background parameters 80b include the image position relative to its background, distance or dimension of the background relative to the image, brightness or color of the background settings of the OSD (on-screen display). The letter parameters 80a include colors of the letters, fonts, style and size of the letters.

Regarding to the colors, the memory device 32 uses black and white levels for recording the several pieces of letter information 32A. The letter parameters for setting feature of the letter include color information. The controller 34 downloads the color information from letter parameters 80a of control setting 80 for substituting the black and white levels in order to control the display modes of the screen data 42. Since the black and white levels respectively need single 1-bit memory for recording while each of the RBG (Red, Blue and Green) respectively need 24 bits, a relatively large memory space can be economized, which, in turn, lowers the load of the memory device 32.

The screen data 42 further includes, in addition to the text information 4204, at least one icon 4202 stored in the memory device 32. To be more specific, the icon 4202 is stored in the ROM 3202 like the several pieces of letter information 32A. The coding chart 50 further has a group of icon-forming codes 56, one of which corresponds to the icon 4202. Upon initialization of the display system 30, the icon 4202 is downloaded and stored within the RAM (random access memory) 3204.

Upon receipt of the external command, the controller 34 searches and fetches a respective icon-forming code 56 from the coding chart 50 based on the icon 4202. An output buffer 92 is used for temporarily storing the icon 4202 which is combined with the text information 4204 later, thereby displaying the screen data 42 over the display screen 31,

The several pieces of letter information 32A stored within the memory device 32 in reality include letters or characters of multiple languages. However, for the sake of practical application, only those letters to be used in the screen data 42 are stored within the memory device 32 so as to reduce the burden and thus quicken the operation speed of the processor.

The display system 30 of the present invention further includes a template generator 90 and an output buffer 92 in addition to the text buffer 36.

The template generator 90 is used for generating a template for serving as the background feature of the screen display based on the background parameters 80b.

The output buffer 92 is used for temporarily storing the icon 4202 from the memory device 32, the text information 4204 from the text buffer 36, the template from the template generator 90 and thus an assembly of the icon 4202, the text information 4204 and the template is displayed over the display screen 31.

Note that in the present invention, the control setting 80 and the coding chart 50 can be simultaneously downloaded during the initialization of the display system 30 or the former two are downloaded separately after the initialization of the display system 30.

For instance, in case the control setting 80 are downloaded separately after the initialization of the display system 30, the user can click a respective function in the menu or he can click a respective icon 4202 in order to display a corresponding text information 4204. Regarding the coding chart 50, the same can be either fully or partially downloaded and is temporarily stored in the register 3402 after the initialization of the display system 30 so as to economize the hardware and thus increase the function ability of the display system 30.

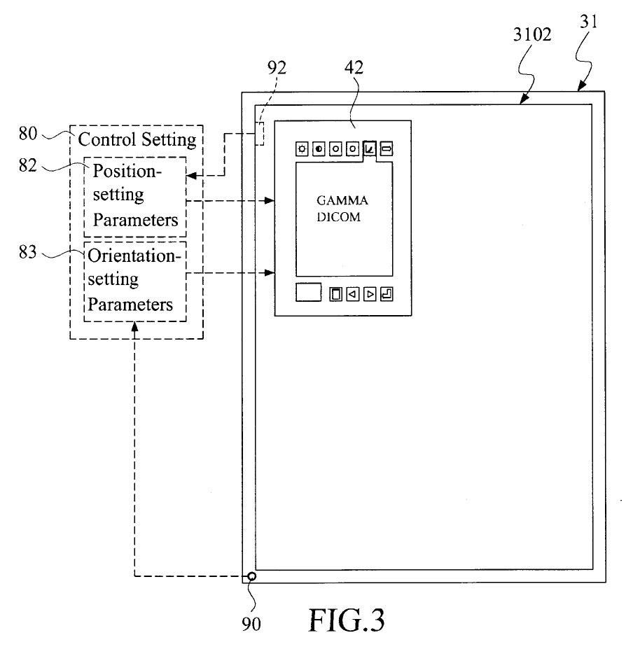

FIG. 3 illustrates how the control setting 80 is applied to control the screen data 42 in the screen display 31 to change its position and orientation with respect to the display screen of the display system 30 of the present invention.

Sometimes, the display screen 31 applied in the medical field is required to change from its initial position to a predetermined position. Under such condition, the control setting 80 further includes position-setting parameters 82 and orientation-setting parameters 83 cooperating with the position-setting parameters 82 for determining display modes so as to define a position and orientation of the screen data 42 in the display screen 31 when the latter is rotated to the predetermined position.

In real application, the position-setting parameters 82 and orientation-setting parameters 83 of the screen display in the display screen 31 can be selected by menu of OSD externally. Under this condition, the display system 30 of the present invention further includes a press button 90 and a touch button 92. The press button 90 corresponds to the orientation-setting parameters 83 and depression of which results in rotation of the screen data 42 relative to the display screen 31, thereby changing the orientation of the screen data 42.

In addition, rotation of the display screen 31 from its initial position to the predetermined position will be activated by the touch button 92, such as by means of magnetic reed or switches, thereby retaining the screen data 42 at the upper left corner of the display screen 31, as shown in FIG. 3.

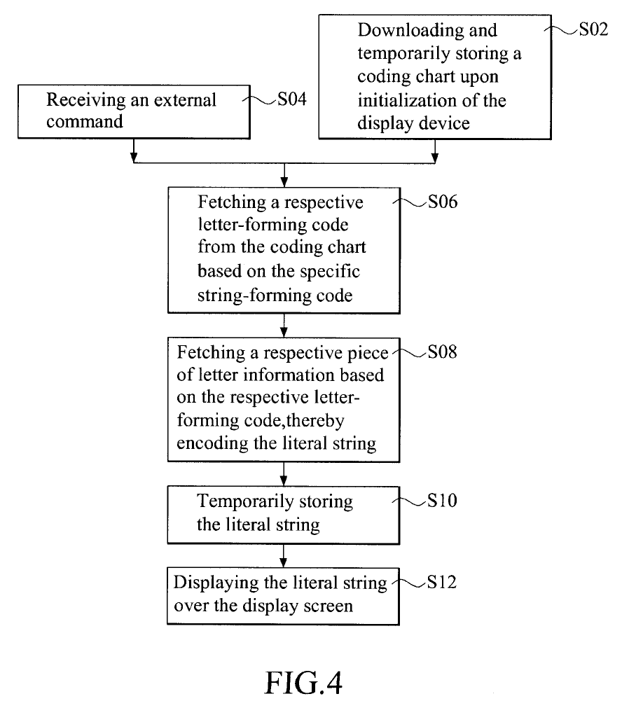

FIG. 4 shows a block diagram illustrating the steps in the display method of the present invention to be applied in the display system 30 for controlling the on-screen display (the screen data 42) in the display screen 31. The screen data 42 is in the form of the text information 4204 includes a display column 22 consisting of the literal string 4204a formed by combining several numbers of letters 24. The method accordingly includes the following steps.

According to the step S02, upon initialization of the display device, a coding chart 50 is downloaded and temporarily stored, wherein the coding chart 50 includes a group of string-forming codes 52 and a group of letter-forming codes 54 corresponding to the several pieces of letter information 32A. The coding chart 50 further includes a group of icon-forming codes 56.

The coding chart 50 has different groups of string-forming codes 52 for encoding different types of the literal strings 4204a.

At the same time, the control setting 80 is downloaded together with the coding chart 50 during the initialization of the display device. The control setting 80 is used for setting display modes of the screen data 42, wherein the control setting 80 includes parameters for setting the feature of the screen display in the display screen 31. In addition, the several pieces of letter information 32A in fact are black and white levels. The control setting 80 may include color information, which is downloaded for substituting the black and white levels in order to control the display modes of the screen data 42.

According to the step S04, an external command corresponding to a specific string-forming code 52 is received.

A respective letter-forming code 54 is fetched from the coding chart 50 based on the specific string-forming code 52, according to the step S06.

According to step S08, a respective piece of letter information 32A is fetched from the memory device 32 based on the respective letter-forming code 54 for encoding the literal string 4204a.

The literal string 4204a is stored temporarily, according to the step S10,

According to the step S12, the literal string 4204a is displayed over the display screen 31.

In addition, upon receipt of the external command, a respective icon-forming code 56 is searched and fetched from the coding chart 50 based on the icon 4202, thereby encoding the literal string 4204a and displaying the literal string 4204a over the display screen 31. The text information 4204 is corresponding to the icon 4202.

Note that the display screen 31 applied in the medical field is required to change from its initial position to a predetermined position for a medical practitioner to diagnose the disease (for example, viewing an X-ray film). The orientation of the text information is required to be rotated from its initial position. Under such condition, the control setting 80 includes position-setting parameters 82 and orientation-setting parameters 83 cooperating with the position-setting parameters 82 for determining display modes so as to define a position and orientation of the screen data 42 in the display screen 31 when the latter is rotated to the predetermined position.

As explained above, in the display method of the present invention, the several pieces of letter information 32A are stored in the memory device 32. The controller 34 fetches the string-forming codes 52 and the letter-forming codes 54 from the coding chart 50 in order to encode the literal string 4204a. Therefore, a relatively large memory device can be economized and consequently lowers the processing load of the processor, thereby quickening the operation speed of the processor. In real application, the storage space or load of the ROM 3202 and the RAM 3204 is directly reduced.

While the invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A display system for controlling an on-screen display within a display screen of a display device, the on-screen display being a screen data in the form of text information including a display column consisting of a literal string formed by combining several numbers of letters, the system comprising:
a memory device for storing several pieces of letter information;
a controller for downloading and temporarily storing a coding chart upon initialization of the display device, said coding chart including a group of string-forming codes and a group of letter-forming codes, the coding chart further including different groups of string-forming codes for encoding different types of the literal strings, the string-forming codes and the letter-forming codes being corresponding to the several pieces of letter information in the memory, upon receipt of an external command corresponding to a specific string-forming code, the controller fetching a respective letter-forming code from the coding chart based on the specific string-forming code and a respective piece of letter information from the memory based on the respective letter-forming code, thereby encoding the literal string and displaying the literal string over the display screen.

2. The display system according to claim 1, wherein the controller further includes a register for temporarily storing the downloaded coding chart during initialization of the display device.

3. The display system according to claim 1, wherein said memory device includes a ROM (read-only memory) for permanently storing the several pieces of letter information and a RAM (random access memory) for temporarily storing the several pieces of letter information downloaded from the ROM during initialization of the display device.

4. The display system according claim 1, wherein said controller further downloads a control setting during initialization of the display device, said control setting being used for setting display modes of the on-screen display.

5. The display system according to claim 4, wherein the display device further includes
a ROM (read-only memory) for storing the control setting and the coding chart; and
a MCU (microprocessor) for fetching the control setting and the coding chart from the ROM and transferring to the controller during initialization of the display device.

6. The display system according to claim 5, wherein upon receipt of said external command, said MCU conducting said fetching and transferring of the control setting and the coding chart from the ROM to the controller.

7. The display system according to claim 1, wherein the display device further includes a software device for conducting said fetching and transferring of the control setting and the coding chart from the ROM to the controller.

8. The display system according to claim 4, wherein the display screen is rotatable from its initial position to a predetermined position, the control setting including position-setting parameters and orientation-setting parameters cooperating with the position-setting parameters for determining display modes so as to define a position and orientation of the screen data in the display screen when the display screen is rotated to the predetermined position.

9. The display system according to claim 8, wherein the display device further includes a press button corresponding to said orientation-setting parameters and depression of which results in rotation of the screen data relative to the display screen and a touch button activated due to rotation of the display screen from the initial position, thereby retaining the screen data at the predetermined position within the display screen.

10. The display system according to claim 4, wherein the screen data further includes at least one icon stored within said memory device, said coding chart further having a group of icon-forming codes, one of which corresponds to said icon stored in said memory, upon receipt of said external command, said controller fetching a respective icon-forming code from said coding chart based on the icon, thereby encoding the literal string and displaying the literal string over the display screen.

11. The display system according to claim 10, wherein the control setting further includes background parameters for setting a background feature of a screen display in the display screen and letter parameters for setting feature of a letter, the display system further comprising:
a text buffer for temporarily storing the text information formed by combining said letter parameters and the literal string from the memory device;
a template generator for generating a template for serving as the background feature of the screen display based on the background parameters;
an output buffer for temporarily storing the icon from said memory device, the text information from said text buffer, the template from the template generator and an assembly of the icon, the text information and the template being displayed over the display screen.

12. The display system according to claim 11, wherein said memory device uses black and white levels for recording the several pieces of letter information, said letter parameters for setting feature of the letter including color information, said controller further downloading said color information from other source for substituting the black and white levels in order to control the display modes of the screen data.

13. The display system according to claim 12, wherein the display column further consists of a bar chart.

14. A display method for controlling an on-screen display within a display screen of a display device, the on-screen display being a screen data in the form of a text information including a display column consisting of a literal string formed by combining several numbers of letters, the display method comprising:
(i) downloading and temporarily storing a coding chart upon initialization of the display device, said coding chart including a group of string-forming codes and a group of letter-forming codes, the coding chart further having different groups of string-forming codes for encoding different types of the literal strings, the string-forming codes and the letter-forming codes being corresponding to the several pieces of letter information;
(ii) upon receipt of an external command corresponding to a specific string-forming code, fetching a respective letter-forming code from the coding chart based on the specific string-forming code;
(iii) fetching a respective piece of letter information based on the respective letter-forming code, thereby encoding the literal string;
(iv) temporarily storing the literal string; and
(v) displaying the literal string over the display screen.

15. The display method according to claim 14, further comprising a step of downloading a control setting during initialization of the display device for setting display modes of the screen data.

16. The display method according to claim 15, wherein the display screen is rotatable from its initial position to a predetermined position, the control setting including position-setting parameters and orientation-setting parameters cooperating with the position-setting parameters for determining display modes so as to define a position and orientation of the screen data in the display screen when the display screen is rotated to the predetermined position.

17. The display method according to claim 15, wherein the control setting further includes background parameters for setting a background feature of a screen display in the display screen and letter parameters for setting feature of a letter.

18. The display method according to claim 17, wherein black and white levels are used for recording several pieces of letter information, the control setting further downloading color information from other sources for substituting the black and white levels in order to control the display modes of the screen data.

19. The display method according to claim 15, wherein the display column further consists of a bar chart.

20. The display method according to claim 15, wherein the screen data further includes at least one icon, said coding chart further having a group of icon-forming codes, one of which corresponds to said icon, upon receipt of said external command, searching and fetching a respective icon-forming code from said coding chart based on the icon, thereby encoding the literal string and displaying the literal string over the display screen.
